(19) United States
(12) Patent Application Publication
(10) Pub. No.: US 2016/0180206 A1
(43) Pub. Date: Jun. 23, 2016

(54) COMPUTER FILE AND METHOD FOR READING THEREOF

(71) Applicant: HAREL NAOR, KIBBUTZ DAN (IL)

(72) Inventor: HAREL NAOR, KIBBUTZ DAN (IL)

(21) Appl. No.: 14/975,798

(22) Filed: Dec. 20, 2015

(30) Foreign Application Priority Data
Dec. 21, 2014 (IL) 236391

(51) Int. Cl. G06K 19/06; G06K 9/62

(52) U.S. Cl. CPC G06K 19/06028; G06K 19/06037; G06K 19/06187; G06K 9/6217; G06K 2019/06253

(57) ABSTRACT

A computer file of a document being readable by a computer application and editable thereby for not limiting fields thereof to a pre-determined format, the computer file including an optical machine-readable representation.

### CROSS-REFERENCE TO RELATED APPLICATIONS

This application claims the benefit of priority from Israel Patent Application No. 236391, filed Dec. 21, 2014, the disclosure of which is incorporated herein by reference.

### TECHNICAL FIELD

The invention relates to the field of management of computer files. More particularly, the invention relates to a method and file for handling printed information.

### BACKGROUND

A visit card may include an optical representation including the plain text of the letters, and including a fields limited to a certain format. The letters may then be transferred to produce a new record in a Contacts application, wherein the records thereof are adapted to that certain format. The user may then edit it in the application running in the computer.

However, a person receiving a printed document cannot copy it to the computer, as formatted, for further editing the document as a formatted document.

The user may scan, apply OCR (Optical Character Recognition), but not directly use it as a file.

However, this is critical regarding an accountant receiving receipts, and having to type the contents by the accountant program.

The above-mentioned visit card application is not usable since it relates to pre-determined fields of the visit card, and to a pre-determined computer application.

All the methods described above have not yet provided satisfactory solutions to the problem mentioned above.

### SUMMARY

It is an object of the invention to provide a method and apparatus for transferring printed document into the computer.

It is an object of the invention to provide a solution to the above-mentioned and other problems of the prior art.

In one aspect, the invention is directed to a computer file of a document being readable by a computer application and editable thereby for not limiting fields thereof to a pre-determined format, the computer file including an optical machine-readable representation.

### BRIEF DESCRIPTION OF THE DRAWINGS

Embodiments, features, aspects and advantages of the invention are described herein in conjunction with the following drawings:

FIG. 1 depicts a prior art usage of an optical machine-readable representation.

FIG. 2 is an example of the optical machine-readable representation.

FIG. 3 is an example of a portion of the code of the document of FIG. 2, and the portion of the optical machine-readable representation of FIG. 2 corresponding thereto.

FIG. 4 depicts the geometric patterns of FIG. 3 within the optical machine-readable representation.

FIG. 5 depicts the first step of using the optical machine-readable representation of FIG. 2.

FIG. 6 depicts the fourth step of using the optical machine-readable representation of FIG. 2.

FIG. 7 depicts the fifth step of using the optical machine-readable representation of FIG. 2.

FIG. 8 depicts the seventh step of using the optical machine-readable representation of FIG. 2.

### DETAILED DESCRIPTION

The invention will be understood from the following detailed description of embodiments which are meant to be descriptive and not limiting. For the sake of brevity, some well-known features, methods, systems, procedures, components, circuits, and so on, are not described in detail.

The invention utilizes the following prior art by adding features thereto.

“A computer file is a resource for storing information, which is available to a computer program and is usually based on some kind of durable storage” (from http://en.wikipedia.org/wiki/Computer_file)

The term “alphanumeric characters” refers herein to a combination of alphabetic and numeric characters. These characters may include letters in any language, digits, other symbols, such as punctuation and mathematical symbols, and any text constructed from this collection.

The term “plain text” refers herein to sequential textual alphanumeric characters, which are not formatted, as explained following.

ASCII, abbreviated from American Standard Code for Information Interchange, is an example of a character-encoding scheme. Thus, an ASCII code file converts each code of a plain text file, to one letter.

Thus a plain text file may include, according to one embodiment, a series of ASCII codes, for being encoded to human-readable letters.

The term “styled text” refers herein to sequential styled textual material. An exemplary style includes a font.

Thus a styled text file includes a series of codes, including codes of the text and codes of the style to be applied to each text, for being encoded to human-readable styled letters.

The term “laid text” refers herein to a layout of textual material, either being styled or non-styled.

An exemplary layout includes laying of the text in tables, footnotes, etc.

Thus a laid text file includes a series of codes, including codes of the text, and codes of the layout, for being encoded to human-readable document.

The term “functional text” refers herein to text including a function associated to the text.

Exemplary functions of functions associated to texts include hyperlinks and mathematical connections, e.g., multiply by 2, between cells of a spreadsheet application.

Thus a functional text file includes a series of codes, including codes of the text and codes of the functions, for being encoded and presented by a usable application.

The term “format” refers herein to a combination of providing style, layout and functions to human readable characters.

The styles, layout and functions are typically combined to a format.

The various above-mentioned files of documents package the text and the feature according to a pre-determined encoding, for being used by an application applying a pre-determined decoding.

Typically the extension of the file, such as DOC for a Word editor document, or XLS for Excel spreadsheet document, indicates the application capable of making the encoding and the decoding.

Files are stored on semiconductor, magnetic media, optical media and others.

“Though this is now mostly obsolete, paper was once also an important form of computer data storage.” (from http://en.wikipedia.org/wiki/Paper data storage)

“Paper data storage, typically in the form of paper tape or punched cards, has long been used to store information for automatic processing, particularly before general-purpose computers existed. Information was recorded by punching holes into the paper or cardboard medium and was read mechanically (or later optically) to determine whether a particular location on the medium was solid or contained a hole. A few technologies allow people to make marks on paper that are easily read by machine—these are widely used for tabulating votes and grading standardized tests.

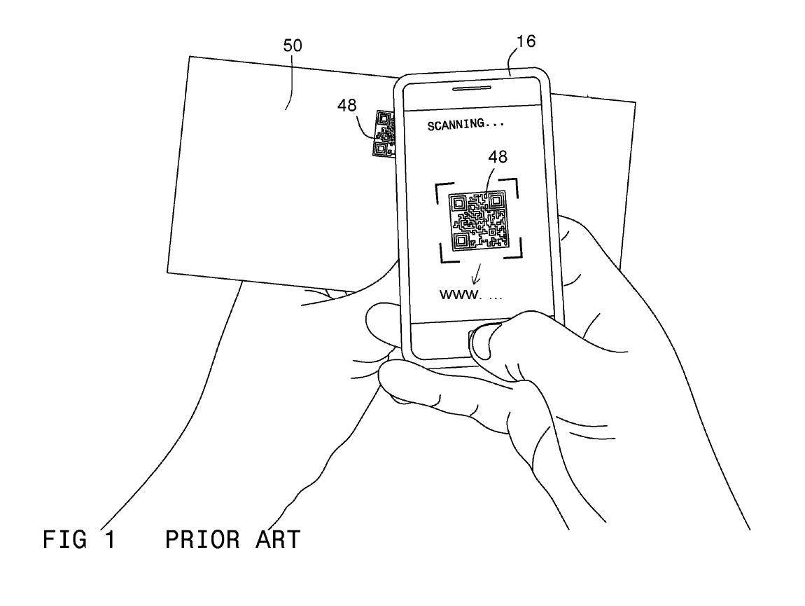

FIG. 1 depicts a prior art usage of an optical machine-readable representation.

A user may receive a printed sheet 50 of an advertisement including an optical machine-readable representation 48 (prior art), for saving the need to type an internet site. The printed sheet 50 sometimes is an invitation to a wedding or another event. Yet the optical machine-readable representation 48 only connects the user to a certain pre-determined site in the internet. The QR code is typically applied for this type of use.

Another use of the prior art optical machine-readable representation 48 is to provide an identification number of a product. The bar code is typically applied for this type of use.

“Barcodes made it possible for any object that was to be sold or transported to have some computer readable information securely attached to it.” (from http://en.wikipedia.org/wiki/Computer_data_storage)

“A barcode is an optical machine-readable representation of data relating to the object to which it is attached. Originally barcodes systematically represented data by varying the widths and spacings of parallel lines, and may be referred to as linear or one-dimensional (1D). Later they evolved into rectangles, dots, hexagons and other geometric patterns in two dimensions (2D). Although 2D systems use a variety of symbols, they are generally referred to as barcodes as well. Barcodes originally were scanned by special optical scanners called barcode readers ” (from http://en.wikipedia.org/wiki/Barcode)

However, the data represented by the prior art barcodes refers to plain text, only.

The invention is directed to a computer file, being a resource for storing information, and being readable by a computer application, is stored by an optical machine-readable representation.

Thus, the optical machine-readable representation may include data of a processed text document, for being read by a computer application, such as a text editor, e.g. Word, a spreadsheet application, e.g. Excel, a database application, e.g. Access, an accounting application, or any other computer application handling files containing alphanumeric characters.

Thus, the optical machine-readable representation may contain data of styled text, of laid text, and of functional text, all described above.

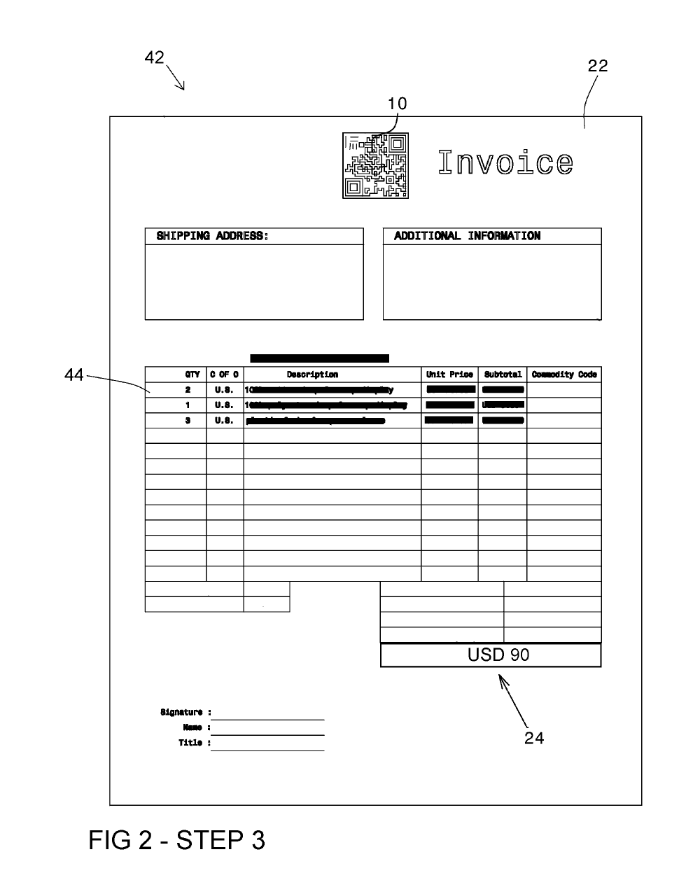

FIG. 2 is an example of the optical machine-readable representation.

According to the example of FIG. 2, an optical machine-readable representation includes all the information of an invoice 22. Invoice 22 which was produced by a computer application, according to this case an accounting application, may be read from optical machine-readable representation 10. The reading opens the computer application, which may further allow editing invoice 22, and produce an updated optical machine-readable representation.

The information, instead of being contained and packaged by a file, allowing reading thereof by a computer application, is contained and packaged, according to the invention, by optical machine-readable representation 10.

Optical machine-readable representation 10, except for containing only the formatted information, such as of the alphanumeric characters, the style thereof, the layout thereof, and the functions of invoice 22, may further include an indication to the application associated thereto, for reading, or even for editing the optical machine-readable representation.

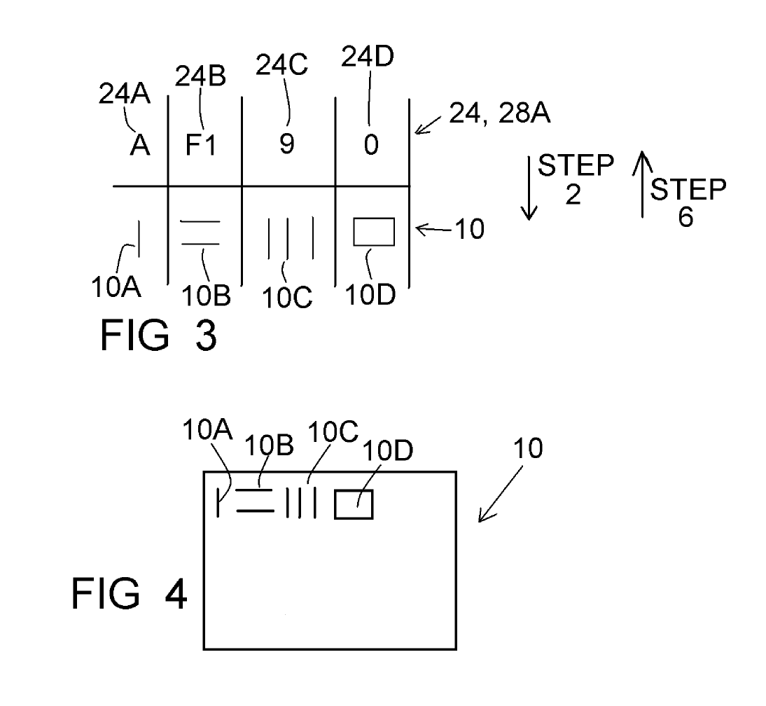

FIG. 3 is an example of a portion of the code of the document of FIG. 2, and the portion of the optical machine-readable representation of FIG. 2 corresponding thereto.

For example, the invoice total 24 of 90 dollars, within a computer file 28A, may be contained in machine-readable representation 10 as following. File 28A typically contains a code 24A, which may be contained in the name of the file, of the computer application associated to the file for reading it, e.g. DOC extension for Word computer application; thus optical machine-readable representation 10 may include a geometric pattern 10A for optically representing code 24A.

A formatting instruction 24B that the 90 dollars are to be formatted by a cell in a table, as shown in invoice 22 may be represented by a geometric pattern 10B; code 24B being the “9” of 90 may be represented by a geometric pattern 10C; and code 24C being the “0” of 90 is shown by a geometric pattern 10D.

Optical machine-readable representation 10 may include further information of the file, such as size, dates, and further attributes.

FIG. 4 depicts the geometric patterns of FIG. 3 within the optical machine-readable representation.

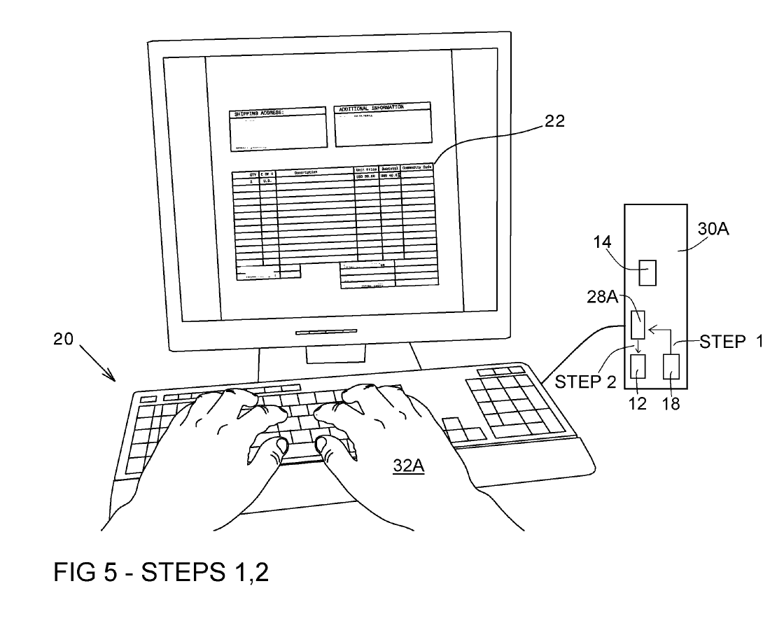

FIG. 5 depicts the first step of using the optical machine-readable representation of FIG. 2.

Thus, at the first step, a first user 32A runs a computer application 18, types a document 22, such as an invoice, by a keyboard 20, and saves a file 28A stored in the storage (disc) of computer 30A of user 32A.

Computer 30A includes an encoder 12, for encoding file 28A to a code of optical machine-readable representation 10, and a decoder 14.

At the second step, encoder 12 encodes file 28A to optical machine-readable representation 10. As depicted in FIG. 3 the second step includes encoding code 24A of file 28A to geometric pattern 10A of optical machine-readable representation 10, code 24B to geometric pattern 10B, code 24C to geometric pattern 10C and code 24D of file 28A to geometric pattern 10D of optical machine-readable representation 10.

According to an embodiment, encoder 12 belongs to the file managing system, e.g. of the operating system Windows, of computer 30A, and is not a function of program 18, and does not belong thereto, as the decoding is not a function of the type of the file. This since each geometric pattern, such as 10B or 10C, of optical machine-readable representation 10 corresponds to a character of file 28A, according to an external conversion table, which need not need recognize program 18.

According to another embodiment, encoder 12 encodes as a function of program 18 and belongs thereto, as the decoding is a function of the type of the file. Each geometric pattern, such as 10B or 10C, of optical machine-readable representation 10 corresponds to a character of file 28A, according to a conversion table, which is familiar with the formatting rules program 18. The encoding and later the decoding is based on a set of formatting rules, which are not included in the rules of program 18, but rather on other formatting rules, e.g., rule of another Extensible Markup Language (XML), which may be accompanied to the encoding and decoding application.

At the third step, depicted in FIG. 2, first user 32A prints document 22 through computer application 18. Computer application 18 produces a print-out 42 of document 22, being a paper media. Computer application 18 adds to print-out 42, except for the conventional formatted text 44, also optical machine-readable representation 10.

Optical machine-readable representation 10 includes all the information of formatted text 44, being a human-readable representation.

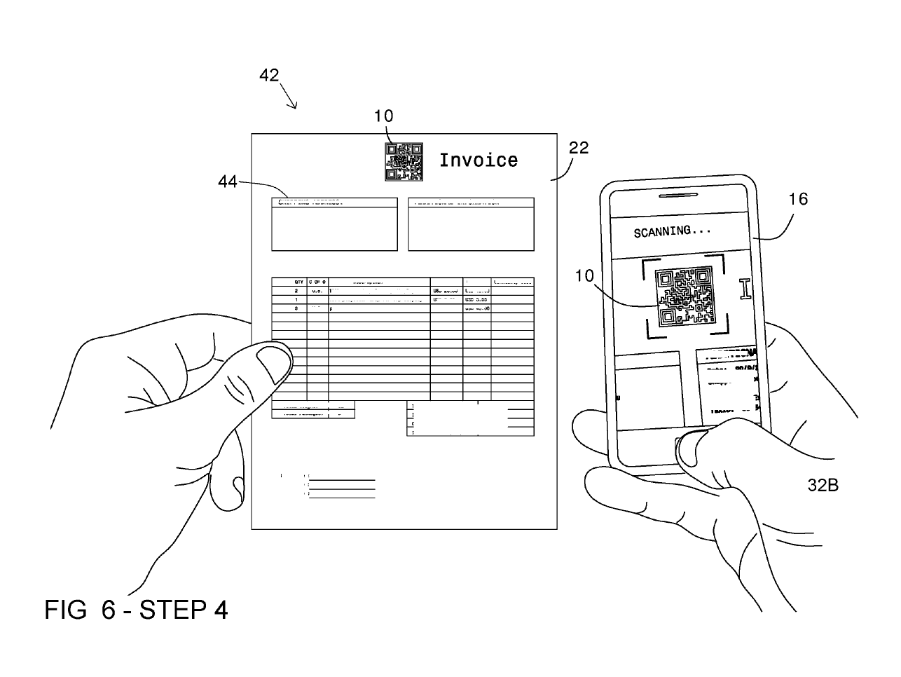

FIG. 6 depicts the fourth step of using the optical machine-readable representation of FIG. 2.

At the fourth step, a second user 32B, receiving print-out 42 scans optical machine-readable representation 10 by an optical reader 16.

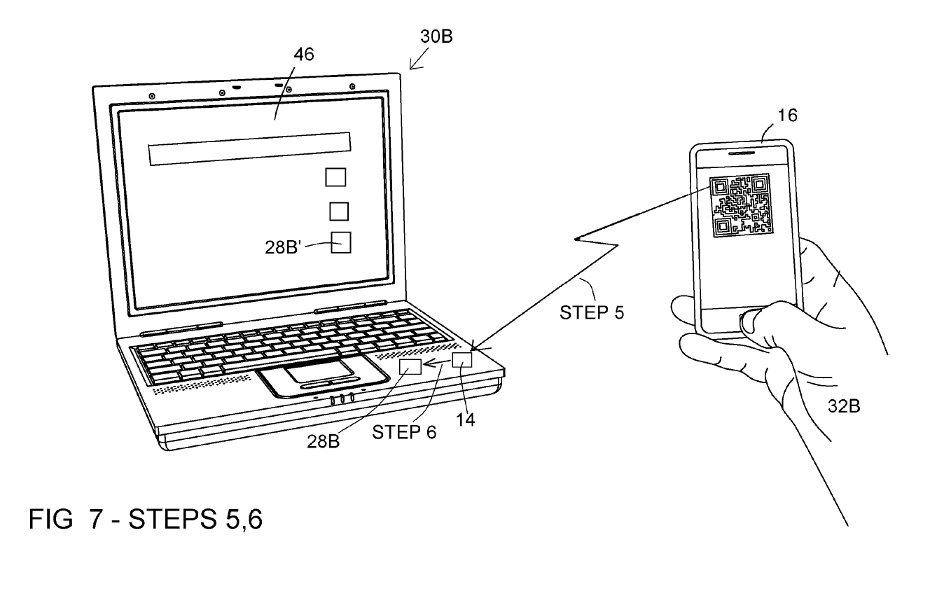

FIG. 7 depicts the fifth step of using the optical machine-readable representation of FIG. 2.

At the fifth step, second user 32B transfers the information of optical machine-readable representation 10 from optical reader 16 to computer 30B of second user 32B.

At the sixth step, decoder 14 of computer 30B decodes optical machine-readable representation 10 to file 28B. As depicted in FIG. 3 the sixth step includes decoding geometric pattern 10A of optical machine-readable representation 10 to code 24A of file 28B; geometric pattern 10B to code 24B; geometric pattern 10C to code 24C; and geometric pattern 10D of optical machine-readable representation 10 to code 24D of file 28B.

File 28B is presented by icon 28B′ of a file managing program 46. e.g., of Explorer, in computer 30B of second user 32B.

According to one embodiment, the result is that file 28B is equal to file 28A. According to another embodiment, file 28B includes most of the information of file 28A.

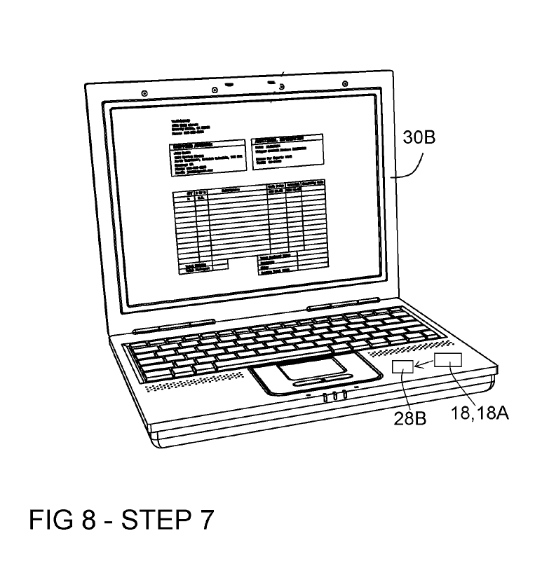

FIG. 8 depicts the seventh step of using the optical machine-readable representation of FIG. 2.

At the seventh step, second user 32B runs computer application 18 or another program, enumerated 18A, which may be compatible to read file 28B, and loads file 28B. Computer application 18 reads file 28B, and thus presents invoice 22.

The term “electronic communication” refers herein to wired or to Radio Frequency (RF) wireless communication.

Thus, file 28A has been copied to file 28B without any electronic communication, but rather by optical communication only.

User 32B may then combine the information of document 22, or even further edit it.

According to another embodiment computer 30B internally includes optical reader 16, and thus computer 30B need not have to copy optical machine-readable representation 10 to file 28B, but rather may directly open document 22 encoded in optical machine-readable representation 10. This is equal to directly opening document 22 stored in an external disk, such as in a USB (Universal Serial Bus) flash drive or in a CD (Compact Disk).

The last embodiment emphasizes that optical machine-readable representation 10 indeed includes all the features of a computer file.

Thus, the prior art is a computer file (10) of a document (22) being readable by a computer application (18) and editable thereby for not limiting fields thereof to a pre-determined format, for example a Word file, Access file, etc., in contrast to a visit card, or any other document, which does not allow formatting or limits the fields.

According to the invention, this computer file (10) includes an optical machine-readable representation (10).

The computer application (18) may include a program selected from a group including: a text editor, a spreadsheet application, an accounting program, a database program or other.

The computer file (10) may further include a human-readable representation (44) of the computer file (10), attached to the optical machine-readable representation, thereby a single media (42) contains a computer file (10) and a human-readable representation (44) thereof.

The human-readable representation (44) of the computer file (10) preferably include alphanumeric characters.

The alphanumeric characters may be styled and laid.

The computer file (10) include sufficient contents for being copied to produce a magnetic storage media file (28B), or a CD storage media file, wherein the computer application (18) reading the computer file (10) and reading the magnetic storage media file (28B), reads the same.

The optical machine-readable representation (10) may include a geometric pattern (10B, 10C) corresponding to each character (24B, 24C) of the magnetic storage media file (28B),

thereby the computer application (18) equally reads the computer file (10) and the magnetic storage media file (28B).

According to one embodiment, the correspondence of each geometric pattern (10B, 10C) to each character (24B, 24C) of the magnetic storage media file (28B) is based on external formatting rules, such as XML.

According to another embodiment, the correspondence of each geometric pattern (10B, 10C) to each character (24B, 24C) of the magnetic storage media file (28B) is based on file managing characteristics only, thus not requiring to be familiar with the computer application (18) which should read the file.

The optical machine-readable representation (10) may include:
a geometric pattern (10C) corresponding to each alphanumeric character (24C) of the computer file (10); and
a geometric pattern (10B) corresponding to each formatting instruction (24B) of the computer file (10) to be applied to the alphanumeric character (24C).

The computer file may further include: encoding and/or a digital certificate and/or a certified copy indication, and/or other accompanied information, such as creation date.

In another aspect, the invention is directed to a method for reading a computer file (28A), the method including the step of:
encoding information of a first computer file (28A) to an optical machine-readable representation (10).

The method according may further include the steps of:
scanning the optical machine-readable representation (10); and
decoding the optical machine-readable representation (10) to a second computer file (28B),
   thereby copying the first computer file (28A) without electronic communication.

Or, the method may further include the steps of:
scanning the optical machine-readable representation (10); and
decoding the optical machine-readable representation (10) for reading the optical machine-readable representation (10) by a second computer (30B), thereby copying the first computer file (28A) without electronic communication.

In the figures and/or description herein, the following reference numerals (Reference Signs List) have been mentioned:
numeral 10 denotes an optical machine-readable representation according to one embodiment of the invention; the optical machine-readable representation may constitute a barcode, QR code, or any other optical representation which may be read by an optical reader and then decoded to a document, which may be packaged by a computer file;
numeral 12 denotes an encoder for encoding codes of a file to codes of the optical machine-readable representation;
numeral 14 denotes a decoder for decoding codes of the optical machine-readable representation to codes of a file, readable by a computer;
numeral 16 denotes an optical reader;
numeral 18 denotes a computer application for reading a document associated to a certain computer application, e.g. a Word document associated to the Word editor; according to the invention, the computer application is capable of producing the optical machine-readable representation of the document;
numeral 18A denotes another computer application for reading the document associated to a certain computer application;
numeral 20 denotes a keyboard of a computer;
numeral 22 denotes a document, such as an invoice or of a laid styled text; the term “document” refers to the contents, which may be stored as a file, presented on a screen, printed, and according to the invention also presented by the optical machine-readable representation;
numeral 24 denotes a character in the document;
numeral 24A denotes a code in the computer file indicating the computer application for reading the file;
numeral 24B denotes a code of a formatting instruction in the computer file;
numerals 24C and 24D each denotes a code in the computer file for one alphanumeric character;
numerals 28A and 28B denote computer file copied one from the other through the optical machine-readable representation;
numeral 283 denotes an icon of computer file 28B;
numerals 30A and 30B denote computers;
numerals 32A and 32B denote users;
numeral 42 denotes a sheet or any visual media, containing a print-out of the document;
numeral 44 denotes formatted text, being readable to a user.
numeral 46 denotes a file managing program;
numeral 48 denotes a prior art optical machine-readable representation; and
numeral 50 denotes a printed sheet.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A computer file of a document being readable by a computer application and editable thereby for not limiting fields thereof to a pre-determined format, said computer file comprising an optical machine-readable representation.

2. A computer file according to claim 1, wherein said computer application comprises a program selected from a group including: a text editor, a spreadsheet application, an accounting program, a database program.

3. A computer file according to claim 1, further comprising a human-readable representation of said computer file, attached to said optical machine-readable representation, thereby a single media contains a computer file and a human-readable representation thereof.

4. A computer file according to claim 1, wherein said human-readable representation of said computer file comprises alphanumeric characters.

5. A computer file according to claim 4, wherein said alphanumeric characters are styled and laid.

6. A computer file according to claim 1, comprising sufficient contents for being copied to produce a magnetic storage media file, wherein said computer application reading said computer file and reading said magnetic storage media file, reads the same.

7. A computer file according to claim 6, wherein said optical machine-readable representation comprises a geometric pattern corresponding to each character of said magnetic storage media file, thereby said computer application equally reads said computer file and said magnetic storage media file.

8. A computer file according to claim 7, wherein said correspondence of each geometric pattern to each character of said magnetic storage media file is based on external formatting rules.

9. A computer file according to claim 7, wherein said correspondence of each geometric pattern to each character of said magnetic storage media file is based on file managing characteristics only.

10. A computer file according to claim 1, wherein said optical machine-readable representation comprises:
a geometric pattern corresponding to each alphanumeric character of said computer file; and
a geometric pattern corresponding to each formatting instruction of said computer file to be applied to the alphanumeric character.

11. A computer file according to claim 1, further comprising at least one member selected from a group consisting of: encoding, digital certificate, certified copy indication, creation date.

12. A method for reading a computer file, said method comprising the step of:
encoding information of a first computer file to an optical machine-readable representation.

13. A method according to claim 12, further comprising the steps of:
scanning said optical machine-readable representation; and
decoding said optical machine-readable representation to a second computer file, thereby copying said first computer file without electronic communication.

14. A method according to claim 12, further comprising the steps of:
scanning said optical machine-readable representation; and
decoding said optical machine-readable representation for reading said optical machine-readable representation by a second computer,
thereby copying said first computer file without electronic communication.
